(19) United States
(12) Patent Application Publication
(10) Pub. No.: US 2026/0142327 A1
(43) Pub. Date: May 21, 2026

(54) COMPOSITE SEPARATOR, AND PREPARATION METHOD THEREFOR AND USE THEREOF

(71) Applicant: Jiangsu Advanced Material Tech Co., Ltd, Jiangsu (CN)

(72) Inventors: Xingqiang Wei, Jiangsu (CN); Xiaoming Wang, Jiangsu (CN); Lei Zhang, Jiangsu (CN); Xuhong Niu, Jiangsu (CN); Haotian Yang, Jiangsu (CN); Qiang Xu, Jiangsu (CN); Jitao Zhu, Jiangsu (CN)

(73) Assignee: Jiangsu Advanced Material Tech Co., Ltd, Jiangsu (CN)

(21) Appl. No.: 19/126,712

(22) PCT Filed: Aug. 28, 2023
(86) PCT No.: PCT/CN2023/115253

§ 371 Date: May 2, 2025

(30) Foreign Application Priority Data
Dec. 28, 2022 (CN) 202211691982.4

(51) Int. Cl. H01M 50/446; H01M 10/0525; H01M 50/417; H01M 50/423; H01M 50/434; H01M 50/443; H01M 50/457; H01M 50/489

(52) U.S. Cl. CPC H01M 50/446; H01M 10/0525; H01M 50/417; H01M 50/423; H01M 50/434; H01M 50/443; H01M 50/457; H01M 50/489

(57) ABSTRACT

A composite separator, and a preparation method therefor and the use thereof. The composite separator comprises a porous substrate and a heat-resistant coating, which is arranged on one or two surfaces of the porous substrate, wherein the heat-resistant coating contains heat-resistant polymer particles, an inorganic filler, and an auxiliary binder, and the heat-resistant polymer particles contain a heat-resistant resin which has an average particle diameter of 10-200 nm and a glass transition temperature of Ts+40° C. or more. The heat-resistant polymer particles and the inorganic filler are used for mixed coating of the heat-resistant coating, and the two are mutually bonded to form a three-dimensional network structure, such that the heat stability of the composite separator is improved. The separator rupture temperature of the composite separator is higher than 200° C., such that the safety performance of a battery is improved and can reach the performance level of an oily coated separator.

### TECHNICAL FIELD

The present application belongs to the technical field of lithium-ion batteries, such as a composite separator, a preparation method therefor, and an application thereof.

### BACKGROUND

The current battery separator is generally coated with a ceramic coating, but the ceramic-coated separator and the electrode plate barely have bonding strength. During the charging and discharging process of the battery, the positive electrode and the negative electrode will repeatedly contract and expand, resulting in the separation of the separator and the electrode plate, and causing problems of battery performance and stability. In view of the shortcomings of the conventional separator, researchers have coated glue on the ceramic coating layer to make the separator and the electrode plate have a certain bonding strength, thus improving the stability of the battery, but the process is complicated and the production cost is high. Meanwhile, the organic-inorganic (ceramic) mixed-coated composite separator has been developed, but the thermal-shrinkage performance of such separator will become very poor compared with the full ceramic-coated separator. Oily-coating separators are safe, but they are costly and cause environmental pollution.

With the increasing concern for new energy sources, the technology development and application of lithium-ion batteries are gradually expanding and maturing. As an energy carrier, the safety performance of lithium-ion batteries is one of the most important criterions to evaluate the quality of a lithium-ion battery. The separator is an important component of lithium-ion batteries, which can play a key role in protection and greatly enhance the safety performance of the battery. Compared with the conventional polyolefin separator and the inorganic/organic-coating separators derived therefrom, aramid-coated separators have the advantages of anti-oxidation, acid/alkali resistance, flame retardancy, friction resistance, and tear resistance, etc., and the thermomechanical strength is much higher than that of the other separators available in the market at present. However, in the existing preparation process of aramid-coated separator, organic solvents are used massively for operations such as dissolution and extraction, and the waste solvents and extraction solutions bring increasingly severe pressure on environmental protection, and also lead to the high product cost.

With the development of new energy vehicle technology, lithium-ion batteries have attracted widespread attention due to high energy density and long cycle life. However, the occasional safety incidents involving lithium-ion batteries are still worrying. As one of the important components of lithium-ion batteries, the separator, although does not provide energy, plays an important role in the safety performance of the battery. The separator separates the positive electrode and the negative electrode of the battery apart, prevents the positive electrode and negative electrode from direct contact and short circuit, and can provide a lithium-ion transmission channel and isolate the electronic transmission. Therefore, the safety of lithium-ion batteries brings higher requirements to the separator.

Polyolefin separator is widely used in lithium-ion battery separators because of low cost, good tensile performance, rich pore structure and other advantages. However, the single-layer polyethylene (PE) and polypropylene (PP) separator has poor high-temperature resistance, which will undergo softening and shrinkage deformation at more than or equal to 120° C., resulting in the short circuit of the battery; and lithium dendrites generated in the cycling process can also cause a short circuit by puncturing the separator, and in serious cases, battery fire or even explosion can occur. Therefore, the single-layer polyolefin separator cannot guarantee the safe service of lithium-ion batteries.

One of the existing solutions is to use the polyolefin film as a substrate, and coat a high-temperature-resistant inorganic ceramic coating on its surface to form a composite separator, and the common inorganic particles are aluminum oxide (Al₂O₃), silicon oxide (SiO₂), zirconium oxide (ZrO₂), and boehmite, etc. This method can effectively enhance the high-temperature resistance and hydrophilic wettability of the separator. However, the ceramic particles have a poor bonding ability with the substrate and are prone to separation from the coating, and if the binder is used to enhance the bonding strength, the separator pores will be blocked and have poor air permeability. Another method is to coat a high-temperature-resistant organic PVDF coating on the surface of the polyolefin separator. Since PVDF is a hydrophobic polymer, the PVDF coating process is mainly an oil-based coating. However, the oil-based coating process requires a large amount of organic solvents, and has great environmental pollution problem and high cost.

Compared with the conventional polyolefin separator and the inorganic/organic-coating separators derived therefrom, aramid-coated separators have the advantages of anti-oxidation, acid/alkali resistance, flame retardancy, friction resistance, and tear resistance, etc., and the thermomechanical strength is much higher than that of the other separators available in the market at present. However, in the existing preparation process of aramid-coated separator, organic solvents are used massively for operations such as dissolution and extraction, and the waste solvents and extraction solutions bring increasingly severe pressure on environmental protection, and also lead to the high product cost. Therefore, there is an urgent need to develop a green material, which should have ultra-high strength and modulus, high-temperature resistance, excellent chemical resistance, and other characteristics. And the corresponding water-based material coating solution needs to be developed to solve the technical problems of poor bonding strength between the coating formed by the oil-based coating slurry and the substrate, low porosity, and uncontrollable pore homogeneity, and environmental pollution problems.

### SUMMARY

The following is a summary of the subject described in detail herein. This summary is not intended to limit the protection scope of the claims.

In order to solve the problems of poor stability, poor bonding strength between the coating and substrate, and environmental pollution of the separator in lithium-ion batteries, the present application provides a composite separator, a preparation method therefor, and an application thereof. For the heat-resistant coating in the composite separator of the present application, a mixed coating of the heat-resistant polymer particle and the inorganic filler is utilized, wherein a three-dimensional network structure is formed by the internal bonding of the heat-resistant polymer particle or of the heat-resistant polymer particle and ceramic particle, which improves the thermal stability of the composite separator. The composite separator having a film rupture temperature of greater than 200° C. improves the safety performance of the battery, and reaches the performance level of the oil-based coating, and the bonding strength between the coating and the substrate is higher, and the electrolyte wettability is better. Meanwhile, the water-based coating greatly reduces the use of oily solvents, reduces costs, improves production safety, and is environmentally friendly.

An object of the present application is to provide a composite separator, which comprises:
a porous substrate and a heat-resistant coating arranged on one surface or both surfaces of the porous substrate, wherein the heat-resistant coating contains a heat-resistant polymer particle, an inorganic filler, and an auxiliary binder.

In one embodiment, the heat-resistant polymer particle contains a heat-resistant resin having an average particle size of 10-200 nm and a glass transition temperature of more than or equal to Ts+40° C., wherein Ts is a melting point of the porous substrate, and the heat-resistant resin has a weight-average molecular mass of 4.0×10⁴-2×10⁶. When the heat-resistant resin having a weight-average molecular mass in this range is used to further form a water-based coating slurry and coated on the porous substrate, a better and more homogeneous heat-resistant particle coating can be formed; in addition, when the average particle size of the heat-resistant polymer particle is within the range of 10-200 nm, the heat-resistant polymer particle or the heat-resistant polymer particle and the inorganic filler can be better connected internally to form a network structure.

In one embodiment, the heat-resistant resin is selected from at least one of polyimide, aramid 1414 (poly(p-phenylene terephthamide)), aramid 1413 (poly(m-phenylene terephthamide)), aramid 1313 (poly(m-phenylene isophthalamide)), thienyl aramid, pyrrolyl aramid, furanyl aramid, pyridyl polyamide, polyamide-imide, polyetherimide, polysulfone, polyketone, polyether ketone, polyether ether ketone, poly(p-phenylene benzobisoxazole), and cellulose.

In one embodiment, the inorganic filler has an average particle size of 10-1000 nm, and the inorganic filler is selected from at least one of ceramic, a metal oxide, a metal hydroxide, a metal carbonate, silicate, kaolin, talc, mineral, and glass.

In one embodiment, the inorganic filler is selected from at least one of boehmite, aluminum oxide, silicon dioxide, barium titanate, titanium dioxide, zinc oxide, magnesium oxide, magnesium hydroxide, zirconium oxide, or an oxide solid electrolyte.

In one embodiment, the oxide solid electrolyte is selected from at least one of a perovskite-type electrolyte, a NASICON-type electrolyte, a LISICON-type electrolyte, a garnet-type electrolyte, and a LiPON-type electrolyte.

In one embodiment, a volume concentration of the heat-resistant polymer particle is VP₁ relative to the heat-resistant polymer particle and the inorganic filler, a critical volume concentration of the heat-resistant polymer particle is VP₀, and a volume concentration of the inorganic filler with a particle size of less than 100 nm is VP₂ relative to the heat-resistant polymer particle and the inorganic filler: VP₀, VP₁, and VP₂ meet the following conditions:
in a case where the inorganic filler is one filler or a mixture of a plurality of fillers and the inorganic filler has an average particle size of greater than 100 nm, the condition of VP₀≤VP₁≤100% is met;
in a case where the inorganic filler is a mixture of a plurality of fillers and at least one filler has an average particle size of less than 100 nm, the condition of VP₀≤VP₁+VP₂≤100% is met;
wherein VP₀=0.685*DP/(0.685*DP+0.5233DT), DP is an average diameter of the heat-resistant polymer particle, and DT is an average diameter of the inorganic filler.

Because the hardness of the heat-resistant polymer particle is lower than that of the inorganic filler, the thermal-shrinkage resistance of the heat-resistant polymer particle is inferior to that of the inorganic filler. With less proportion of the heat-resistant polymer particle, the thermal-shrinkage performance of the separator is better, but when the proportion is too low, the high rupture performance cannot be achieved (holding for 1 h at a temperature of Ts+40° C.). When the proportion of the heat-resistant polymer particle is higher, the porosity is higher, more electrolyte can be maintained, and the electrochemical performance of the battery is improved, and the heat-resistant polymer with a lower density results in a lower density of the coating, which can improve the mass energy density of the battery. However, when the proportion of heat-resistant polymer particle is too high, the coating is prone to a large number of cracks, which is harmful to the battery safety. Therefore, in order to ensure that the composite separator has a high rupture temperature and stability, in the present application, a volume ratio of the heat-resistant polymer particle to a total volume of the heat-resistant polymer particle and the inorganic filler can be VP₀ to 0.5×(VP₀+1).

In view of the high cost of the heat-resistant polymer, from the viewpoint of cost saving, in one embodiment, the volume ratio of the heat-resistant polymer particle to the total volume of the heat-resistant polymer particle and the inorganic filler is VP₀ to 0.5×(VP₀+0.7).

In one embodiment, the auxiliary binder comprises a binder and a coupling agent, an additive amount of the binder is 0.5-10 wt % of a total mass of the heat resistant polymer particle and the inorganic filler, and an additive amount of the coupling agent is 1-20 wt % of a total mass of the heat-resistant polymer particle and the inorganic filler. The auxiliary binder improves the bonding among the heat-resistant polymer particles, or between the heat-resistant polymer particle and the inorganic filler, and between the inorganic filler and the porous substrate.

In one embodiment, the coupling agent is a silane coupling agent, and in the heat-resistant coating, a content of Si atoms introduced from the silane coupling agent is 0.05-5 wt % of a mass of the heat-resistant coating.

In one embodiment, the binder is selected from at least one of polyvinyl alcohol, polyacrylic acid, polyurethane, polyimide, and carboxymethyl cellulose, and the silane coupling agent is selected from at least one of vinyltriethoxysilane, vinyltrimethoxysilane, vinyltris(β-methoxyethoxy) silane, γ-aminopropyltriethoxysilane, γ-glycidoxypropyl trimethoxysilane, and γ-methacryloxypropyltrimethoxysilane. The coupling agent can be selected from an aluminate coupling agent and a titanate coupling agent besides the above coupling agent.

From the viewpoint of obtaining good mechanical characteristics and internal resistance, a thickness of the porous substrate in the present application is optionally 1-25 μm: from the viewpoint of inhibiting short circuit of the battery and obtaining sufficient ion transmission, a Gurley value of the porous substrate in the present application is optionally 20-300 s/100 cc. It should be noted that the porous substrate preferably comprises a thermoplastic resin to provide a closing function to the porous substrate. The closing function refers to the following function: when the temperature of the battery is increased, the material of the porous substrate melts to block the pores of the porous substrate, thereby blocking the movement of ions and preventing thermal runaway of the battery. As a thermoplastic resin, a material of the porous substrate in the present application is optionally a thermoplastic resin having a melting point of less than 200° C.

In one embodiment, the thermoplastic resin is selected from polyethylene terephthalate and/or polyolefin.

In one embodiment, the polyolefin has a weight-average molecular mass Mw of 100000-5000000, and the polyolefin is polyethylene and/or polypropylene. When the Mw of the polyolefin is more than or equal to 100000, the porous substrate can be given sufficient mechanical characteristics; on the other hand, when the Mw of the polyolefin is less than or equal to 5000000, the porous substrate formed by the polyolefin has a good closing characteristic, and the molding of porous film is easy to perform.

In order to obtain a heat-resistant coating with a suitable thickness and uniformity, a loading amount of the heat-resistant coating in the present application is optionally 1-9 g/m².

An object of the present application is to provide a preparation method for the composite separator, comprising the following step:
(1) synthesizing a heat-resistant resin;
(2) preparing a dispersion of a heat-resistant polymer particle by using the heat-resistant resin obtained in step (1);
(3) preparing a coating slurry: adding the dispersion of the heat-resistant polymer particle obtained in step (2), an inorganic filler, a binder, and a coupling agent to a water-based solvent and mixing well to obtain the coating slurry: it can be seen that the dispersion system of the coating slurry in the present application is a water-based solvent; and
(4) coating the coating slurry on any one surface or both surfaces of the porous substrate and curing to obtain the composite separator.

In one embodiment, the water-based solvent in step (3) is selected from one or a mixed solution of more than one of deionized water, ethanol, ethylene glycol, glycerol, isopropanol, propylene glycol, butanol, and acetic acid: in the present application, the oily solvents such as NMP and DMAc commonly used in the art are abandoned, while the more friendly water-based solvents are used, which reduces the coating production cost, reduces coating pollution to the environment, and improves production safety.

The coating slurry further comprises one or more of 0.05-7 wt % of a surfactant, 0.05-9 wt % of a dispersant, 0.02-7 wt % of a wetting agent and 0.04-4 wt % of a defoaming agent added based on a mass of the coating slurry.

In one embodiment, the coating slurry in step (3) has a solid content of 2-80%, and a method for the coating in step (4) is selected from at least one of an electrostatic spraying method, a blade-coating method, a spin-coating method, an extrusion coating method, a transfer coating method, an immersion coating method, and a gravure or micro-gravure coating method.

In one embodiment, the coating slurry has a solid content of 4-40%.

In one embodiment, in order to improve the wettability for the coating slurry used to form the heat-resistant coating, step (4) of the present application optionally further comprises performing a surface treatment on the porous substrate without impairing the properties of the porous substrate, and the surface treatment is any one of a corona treatment, a plasma treatment, a flame treatment, and a UV irradiation treatment.

An object of the present application is to provide an application of the composite separator in a lithium-ion battery, and the lithium-ion battery comprises a positive electrode, a negative electrode, and the composite separator.

The beneficial effects of the present application are as follows.

(1) In the present application, the heat-resistant polymer particle and inorganic filler are combined for coating: in the resulting heat-resistant coating, a three-dimensional network structure can be formed among the heat-resistant polymer particles or between the heat-resistant polymer particle and the inorganic filler, improving the thermal stability of the composite separator. In addition, the auxiliary binder can improve the connection between the heat-resistant polymer particles or between the heat-resistant polymer particle and the inorganic filler to form a three-dimensional network structure, improve the bonding strength between the heat-resistant coating and the porous substrate, and greatly improve the stability of the composite separator, so that the rupture temperature of the composite separator is greater than 200° C., the safety performance of the battery is improved, and the performance level of the oil-based coating is reached.

(2) In the present application, the use of the thermoplastic resin having a melting point of less than 200° C. realizes that the porous substrate melts and flows into the pores of the heat-resistant coating to block the pores when the temperature is increased, thus realizing the closing effect of the separator, thereby blocking the movement of ions, preventing thermal runaway of the battery, and improving the safety performance of the battery.

(3) In the preparation method of the present application, the use of oily solvents is avoided, and the use of environmentally friendly water-based solvents reduces the coating production cost, reduces coating pollution to the environment, and improves production safety.

After the detailed description is read and understood, other aspects can be understood.

### BRIEF DESCRIPTION OF DRAWINGS

The accompanying drawings are used to provide a further understanding of the technical solutions herein, form part of the specification, and are used in conjunction with the embodiments of the present application to explain the technical solutions herein, but do not constitute a limitation to the technical solutions herein.

The present application is further described below by the accompanying drawings and embodiments.

FIG. 1 shows a structural schematic diagram of the composite separator prepared in Example 1 of the present application;

FIG. 2 shows an SEM image of the surface of the composite separator prepared in Example 1 of the present application;

FIG. 3 shows a structural schematic diagram of the composite separator prepared in Example 4 of the present application:

FIG. 4 shows rupture temperature curves from TMA test of the composite separators prepared in Example 2 and Example 7 of the present application, wherein a—the curve of Example 2 and b—the curve of Example 7.

### DETAILED DESCRIPTION

The technical solutions in the embodiments of the present application will be clearly and completely described below, and it is obvious that the described embodiments are only a part of the embodiments of the present application but not all embodiments. The following description of at least one exemplary embodiment is merely illustrative and not to be taken as any limitation on the present application or its application. Based on the embodiments in the present application, all other embodiments obtained by those skilled in the art without creative labor are within the protection scope of the present application.

Unless otherwise specifically described, the values involved in these embodiments do not limit the scope of the present application. The technology and methods known by those skilled in the relevant art may not be disclosed in detail, but in appropriate cases, the technology and methods should be considered as a part of the specification. In all embodiments illustrated and discussed herein, any specific values should be considered merely as exemplary but not as limitative. Therefore, other examples of exemplary embodiments may have different values.

The experimental methods without conditions specified in the following embodiments are usually performed in accordance with national standards: if there is no corresponding national standard, they are carried out in accordance with general international standards, or standard requirements proposed by the relevant enterprises. Unless otherwise stated, all the “parts” are parts by weight and all the “percentages” are percent by weight.

### Example 1

### Step 1: Synthesizing a Heat-Resistant Resin

Under the condition of Ar atmosphere and stirring, the system was controlled at 90° C., and solubilizer calcium chloride was added to NMP (N-methylpyrrolidone) and dissolved, where an additive amount of the solubilizer was 5% of a mass of the NMP: the reaction system was stirred for about 1 h, and then cooled to room temperature, added with m-phenylenediamine and continued to be stirred, and after the complete dissolution of m-phenylenediamine, the reaction system was cooled to 3° C., and then added with m-phthaloyl dichloride (its additive amount was equal to the molar amount of m-phenylenediamine), the rotational speed was increased to 800 r/min to make the m-phthaloyl dichloride dissolve completely, the reaction was continued for 40 min, and then the reaction system was heated to 75° C., and continued to obtain m-aramid (i.e., aramid 1313).

### Step 2: Preparing a Heat-Resistant Polymer Particle Dispersion

(1) 2.0 kg of m-aramid prepared in step 1 was added to a stirrer, added with 28.0 kg of NMP, and stirred for 20 min; water was added under stirring until a turbid m-aramid dispersion was obtained; then 9 kg of isopropanol was added, and continuously stirred uniformly to obtain a first dispersion.
(2) 33 kg of deionized water and 7 kg of isopropanol were added to a stirrer and mixed uniformly to obtain a second dispersion.
(3) The first dispersion was slowly added to the second dispersion with a stirring speed of 5000 r/min to obtain a mixed dispersion containing the heat-resistant polymer particle.
(4) The above mixed dispersion was filtered and washed, and then subjected to a high-pressure homogenization treatment in deionized water to obtain a homogeneous and stable dispersion of the heat-resistant polymer particle.

### Step 3: Preparing a Coating Slurry

The dispersion of the heat-resistant polymer particle obtained in the above step, an aluminum oxide particle (inorganic filler), PVA (binder), γ-glycidoxypropyltrimethoxysilane (coupling agent), and deionized water were mixed uniformly, then added with wetting agent alkylphenol ethoxylate by 0.05 wt % relative to a mass of the coating slurry, and mixed fully and evenly to obtain the coating slurry with a solid content of 38.3%.

The dry weight ratio of the heat-resistant polymer particle to the aluminum oxide particle was 8:92, the dry weight of PVA was 4 wt % of the total mass of the heat-resistant polymer particle and the aluminum oxide particle, and γ-glycidoxypropyltrimethoxysilane was 10 wt % of the total mass of the heat-resistant polymer and the aluminum oxide particle. The average particle size of the heat-resistant polymer particle was 30 nm and the particle size D50 of the aluminum oxide particle was 420 nm.

### Step 4: Coating and Curing of the Coating Slurry

The coating slurry obtained in step 3 was uniformly roller-coated on both surfaces of a 9 μm-thick PE film (the porous substrate), and fully dried in an oven at a temperature of 60° C. to obtain the composite separator.

FIG. 1 shows a structural schematic diagram of the composite separator prepared in this example, wherein 001 is a heat-resistant coating coated on both surfaces of the porous substrate, 002 is a porous substrate, a thickness of a single heat-resistant coating layer is 2.5 μm, and a total thickness of the composite separator is 14 μm.

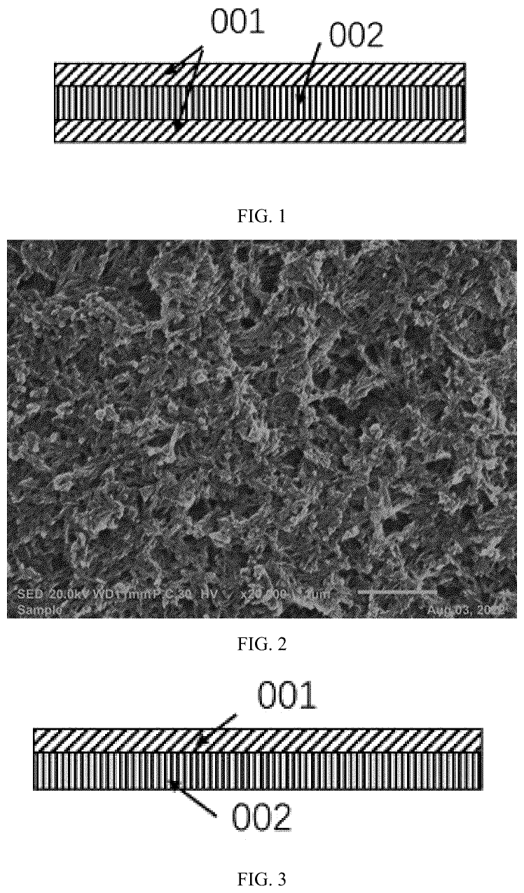

FIG. 2 shows an SEM image of the surface of the composite separator prepared in this example, and it can be seen that the surface structure shows a three-dimensional network structure.

It should be noted that the m-aramid prepared in this example can also be replaced with commercially available m-aramid directly, and the results are the same.

### Example 2

### Step 1: Synthesizing a Heat-Resistant Resin

Under the condition of Ar atmosphere and stirring, the system was controlled at 25° C., DMAC (N,N-dimethylacetamide) and ODA (4,4-diaminodiphenyl ether) were added to a reaction vessel, then 2,5-thiophenedicarbonyl dichloride was added by an equal molar amount of ODA, and then the reaction mixture was stirred and reacted for 0.5 h at 25° C. to obtain thienyl polyamide.

Step 2: Preparing a heat-resistant polymer particle dispersion
(1) 2.67 kg of thienyl polyamide prepared in step 1 and 17.33 kg of DMAC were added to a stirrer, and stirred for 20 min: water was added under the stirring until a turbid thienyl polyamide dispersion was obtained: then 3 kg of isopropanol was added, and continued to be stirred uniformly to obtain a first dispersion.
(2) 25 kg of deionized water and 5 kg of isopropanol were added to the stirrer and mixed uniformly to obtain a second dispersion.
(3) The first dispersion was slowly added to the second dispersion with a stirring speed of 5000 r/min to obtain a mixed dispersion containing the heat-resistant polymer particle.
(4) The above mixed dispersion was filtered and washed, and then subjected to a high-pressure homogenization treatment in deionized water to obtain a homogeneous and stable dispersion of the heat-resistant polymer particle.

### Step 3: Preparing a Coating Slurry

The dispersion of the heat-resistant polymer particle obtained in the above step, boehmite particle (inorganic filler), PVA (binder), γ-glycidoxypropyltrimethoxysilane (coupling agent), and deionized water were mixed uniformly, then added with wetting agent alkylphenol ethoxylate by 0.05 wt % relative to a mass of the coating slurry, and mixed fully and evenly to obtain the coating slurry with a solid content of 38.3%.

The dry weight ratio of the heat-resistant polymer particle to the boehmite particle was 5:95, the dry weight of PVA was 4 wt % of the total mass of the heat-resistant polymer particle and the boehmite particle, and γ-glycidoxypropyltrimethoxysilane was 10 wt % of the total mass of the heat-resistant polymer and the boehmite particle. The average particle size of the heat-resistant polymer particle was 85 nm, the particle size D50 of the boehmite particle 1 was 530 nm, the particle size D50 of the boehmite particle 2 was 50 nm, and a mass ratio of the boehmite particle 1 to boehmite particle 2 was 90:5.

### Step 4: Coating and Curing of the Coating Slurry

The coating slurry obtained in step 3 was uniformly roller-coated on both surfaces of a 9 μm-thick PE film (the porous substrate), and fully dried in an oven at a temperature of 60° C. to obtain the composite separator.

The structural schematic diagram of the composite separator prepared in this example can be seen in FIG. 1, wherein 001 is a heat-resistant coating coated on both surfaces of the porous substrate, 002 is a porous substrate, a thickness of a single heat-resistant coating layer is 2.5 μm, and a total thickness of the composite separator is 14 μm.

The SEM image of the surface of the composite separator prepared in this example is basically the same as FIG. 2, and the surface structure shows a three-dimensional network structure.

### Example 3

### Step 1: Synthesizing a Heat-Resistant Resin

Tetracarboxylic dianhydride and m-phenylenediamine were subjected to a polycondensation reaction to produce polyetherimide. Commercially available polyetherimide can also be used directly.

### Step 2: Preparation of a Heat-Resistant Polymer Particle Dispersion

(1) 2.5 kg of polyetherimide prepared in step 1 or commercially available polyetherimide and 17.5 kg of DMAC were added to a stirrer, and stirred for 20 min; water was added under stirring until a turbid polyetherimide dispersion was obtained: then 6 kg of isopropanol was added, and continued to be stirred uniformly to obtain a first dispersion.
(2) 26 kg of deionized water and 4 kg of isopropanol were added to the stirrer and mixed uniformly to obtain a second dispersion.
(3) The first dispersion was slowly added to the second dispersion with a stirring speed of 5000 r/min to obtain a mixed dispersion containing the heat-resistant polymer particle.
(4) The above mixed dispersion was filtered and washed, and then subjected to a high-pressure homogenization treatment in deionized water to obtain a homogeneous and stable dispersion of the heat-resistant polymer particle.

### Step 3: Preparation of a Coating Slurry

The dispersion of heat-resistant polymer particle obtained in the above step, magnesium hydroxide particle (inorganic filler), PVA (binder), γ-glycidoxypropyltrimethoxysilane (coupling agent), and deionized water were mixed uniformly, and then added with wetting agent alkylphenol ethoxylate by 0.05 wt % relative to a mass of the coating slurry, and mixed fully and evenly to obtain a coating slurry with a solid content of 20%.

The dry weight ratio of the heat-resistant polymer particle to the magnesium hydroxide particle was 10:90, and the dry weight of PVA was 4 wt % of the total mass of the heat-resistant polymer particle and the magnesium hydroxide particle, and γ-glycidoxypropyltrimethoxysilane was 10 wt % of the total mass of the heat-resistant polymer and the magnesium hydroxide particle. The average particle size of the heat-resistant polymer particle was 50 nm, and the particle size D50 of the magnesium hydroxide particle was 800 nm.

### Step 4: Coating and Curing of the Coating Slurry

The coating slurry obtained in step 3 was uniformly roller-coated on both surfaces of a 9 μm-thick PE film (the porous substrate), and fully dried in an oven at a temperature of 60° C. to obtain the composite separator.

The structural schematic diagram of the composite separator prepared in this example can be seen in FIG. 1, wherein 001 is a heat-resistant coating coated on both surfaces of the porous substrate, 002 is a porous substrate, a thickness of a single heat-resistant coating layer is 2.5 μm, and a total thickness of the composite separator is 14 μm.

The SEM image of the surface of the composite separator prepared in this example is basically the same as FIG. 2, and the surface structure shows a three-dimensional network structure.

### Example 4

This example is basically the same as Example 2, and the difference is as follows.

In step 3, no inorganic filler was added, the dry weight of PVA was 5 wt % of the mass of the heat-resistant polymer particle, and γ-glycidoxypropyltrimethoxysilane was 20 wt % of the mass the heat-resistant polymer.

In step 4, the coating slurry obtained in step 3 was uniformly roller-coated on one surface of a 9 μm-thick PE film (the porous substrate) to obtain the composite separator.

The structural schematic diagram of the composite separator prepared in this example can be seen in FIG. 3, wherein 001 is a heat-resistant coating coated on one surface of the porous substrate, 002 is a porous substrate, a thickness of the heat-resistant coating is 3 μm, and a total thickness of the composite separator is 12 μm.

### Example 5

This example is basically the same as Example 2, and the difference is as follows.

In step 2, 5 kg of thienyl polyamide and 20 kg of DMAc were added to a stirrer, and stirred uniformly to obtain a dispersion of the heat-resistant polymer particle, wherein the heat-resistant polymer particle had an average particle size of 200 nm.

In step 3, the dry weight ratio of the heat-resistant polymer particle to the boehmite particle was 30:70, and the dry weight of PVA was 5 wt % of the total mass of the heat-resistant polymer particle and the boehmite particle, and γ-glycidoxypropyltrimethoxysilane was 20 wt % of the total mass of the heat-resistant polymer and the boehmite particle. The particle size D50 of the boehmite particle was 530 nm.

In step 4, the coating slurry obtained in step 3 was uniformly roller-coated on one surface of a 9 μm-thick PE film (the porous substrate) to obtain the composite separator. A total thickness of the composite separator was 14 μm.

### Example 6

This example is basically the same as Example 2, and the difference is as follows.

In step 2, 3.33 kg of thienyl polyamide and 16.67 kg of DMAC were added to a stirrer, and stirred uniformly to obtain a dispersion of heat-resistant polymer particle, wherein the heat-resistant polymer particle had an average particle size of 120 nm.

In step 3, the dry weight ratio of the heat-resistant polymer particle to the boehmite particle was 5:95, and the dry weight of PVA was 5 wt % of the total mass of the heat-resistant polymer particle and the boehmite particle, and γ-glycidoxypropyltrimethoxysilane was 20 wt % of the total mass of the heat-resistant polymer and the boehmite particle. The particle size D50 of the boehmite particle was 530 nm.

In step 4, the coating slurry obtained in step 3 was uniformly roller-coated on one surface of a 9 μm-thick PE film (the porous substrate) to obtain the composite separator. A total thickness of the composite separator was 12 μm.

### Example 7

This example is basically the same as Example 2, and the difference is as follows.

In step 3, the dry weight ratio of the heat-resistant polymer particle to the boehmite particle was 10:90, and the dry weight of PVA was 5 wt % of the total mass of the heat-resistant polymer particle and the boehmite particle. The particle size D50 of the boehmite particle was 530 nm.

In step 4, the coating slurry obtained in step 3 was uniformly roller-coated on one surface of a 9 μm-thick PE film (the porous substrate) to obtain the composite separator, and a total thickness of the composite separator was 12 μm.

### Comparative Example 1

PVDF-HFP particle, boehmite particle, PVA, γ-glycidoxypropyltrimethoxysilane (coupling agent), and deionized water were mixed uniformly, then added with wetting agent alkylphenol ethoxylate by 0.05 wt % relative to a mass of the coating slurry, and mixed fully and evenly to obtain the coating slurry with a solid content of 35%.

The dry weight ratio of the PVDF-HFP particle to the boehmite particle was 30:70, and the dry weight of PVA was 5 wt % of the total mass of the PVDF-HFP particle and the boehmite particle, and γ-glycidoxypropyltrimethoxysilane was 10 wt % of the total mass of the PVDF-HFP particle and the boehmite particle. The particle size D50 of the boehmite particle was 530 nm, and the average particle size of the PVDF-HFP particle was 230 nm.

The above coating slurry was uniformly roller-coated on one surface of a 9 μm-thick PE film, and fully dried in an oven at a temperature of 60° C. to obtain the composite separator, and a total thickness of the composite separator was 12 μm.

The relevant parameters of the raw materials in Examples 1-7 and Comparative Example 1 are listed in Table 1 below. The composite separators obtained in Examples 1-7 and Comparative Example 1 were subjected to performance tests, and the test results are shown in Table 2.

TABLE 1

| | Coating | | | | | | | | |
|---|---|---|---|---|---|---|---|---|---|
| | Heat-resistant polymer | | | | | | | | Coupling |
| | | Glass | | Filler | | Mass ratio | | Binder | agent |
| | | transition | Average | | Average | Heat- | | Percentage | Percentage |
| | | temper- | particle | | particle | resistant | | relative | relative |
| | Type | ature | size A | Type | size B | polymer | Filler | to powder | to powder |
| Example | — | ° C. | nm | — | nm | wt % | wt % | % | % |
| Example 1 | m-Aramid | 270 | 30 | Aluminum | 420 | 8 | 92 | 4 | 10 |
| | | | | oxide | | | | | |
| Example 2 | Thienyl | 268 | 85 | Boehmite | 530, 50 | 5 | 90 + | 4 | 10 |
| | polyamide | | | | | | 5 | | |
| Example 3 | Poly- | 215 | 50 | Magnesium | 800 | 10 | 90 | 4 | 10 |
| | etherimide | | | hydroxide | | | | | |
| Example 4 | Thienyl | 268 | 85 | Boehmite | 530 | 100 | 0 | 5 | 20 |
| | polyamide | | | | | | | | |
| Example 5 | Thienyl | 268 | 200 | Boehmite | 530 | 30 | 70 | 5 | 20 |
| | polyamide | | | | | | | | |
| Example 6 | Thienyl | 268 | 120 | Boehmite | 530 | 5 | 95 | 5 | 20 |
| | polyamide | | | | | | | | |
| Example 7 | Thienyl | 268 | 85 | Boehmite | 530 | 10 | 90 | 5 | — |
| | polyamide | | | | | | | | |
| Comparative | PVDF-HFP | −60 | 230 | Boehmite | 530 | 30 | 70 | 3 | 10 |
| Example 1 | | | | | | | | | |

TABLE 2

| | Composite separator | | | | | |
|---|---|---|---|---|---|---|
| | | | Air | | Coating | |
| | | | permeability | Thermal | peeling | Rupture |
| | Heat-resistant | Thickness | value | shrinkage | force | temperature |
| Example | polymer | μm | s/100 cc | 130° C.@1 h | N/m | ° C. |
| Example 1 | m-Aramid | 2.5 + 9 + 2.5 | 201 | 2.0%/2.1% | 113 | >200 |
| Example 2 | Thienyl | 2.5 + 9 + 2.5 | 205 | 2.2%/2.1% | 123 | >200 |
| | polyamide | | | | | |
| Example 3 | Polyetherimide | 2.5 + 9 + 2.5 | 205 | 3.3%/3.2% | 115 | >200 |
| Example 4 | Thienyl | 9 + 3 | 205 | 4.2%/3.9% | 135 | >200 |
| | polyamide | | | | | |
| Example 5 | Thienyl | 9 + 5 | 245 | 4.0%/4.3% | 135 | >200 |
| | polyamide | | | | | |
| Example 6 | Thienyl | 9 + 3 | 223 | 3.2%/3.3% | 135 | 150 |
| | polyamide | | | | | |
| Example 7 | Thienyl | 9 + 3 | 189 | 2.6%/2.10% | 135 | 150 |
| | polyamide | | | | | |
| Comparative | PVDF-HFP | 9 + 3 | 186 | 2.9%/2.8% | 89 | 150 |
| Example 1 | | | | | | |

The common test methods for rupture temperature in the prior art include the following two methods.

The first method-resistance method to detect the rupture temperature: the separator is impregnated with electrolyte and loaded into the button cell, the two terminals of the cell are connected to the resistance-testing device, the whole device is placed in the oven to be heated with a heating rate of 2° C./min, and meanwhile the temperature and resistance are measured continuously to obtain the resistance-temperature curve. The pore-closing temperature is defined as the temperature at which the resistance exceeds 100 $2, and the rupture temperature is defined as the temperature at which the resistance drops to 10³Ω again.

The second method-thermomechanical analysis (TMA) test: the effective test size between the test fixture: the sample has a width of 5 mm and a length of 10 mm; a loading force is 20 mN, a heating speed is 5° C./min, a temperature range is room temperature to 400° C., and the temperature is raised until the sample breaks (judged by the trend of the deformation), and the temperature at which the sample breaks is the rupture temperature.

In the present application, the rupture temperature of the composite separator was tested using the above thermomechanical analysis (TMA), and none of the composite separators prepared in the present application ruptured when they were kept at a temperature of Ts+40° C. for 1 h.

The relevant parameters of the heat-resistant polymer particle and inorganic filler in Examples 1-7 and Comparative Example 1 are listed in Table 3 below.

TABLE 3

| | Heat- | | | | | | VP₀ (critical | MP₀ (critical |
|---|---|---|---|---|---|---|---|---|
| | resistant | | | | | | volume | mass concent |
| Example | polymer | DP | ρP | Filler | DT | ρT | concentration) | ration) |
| Example 1 | m-Aramid | 30 | 1.38 | Aluminum | 420 | 3.95 | 8.55% | 3.16% |
| | | | | oxide | | | | |
| Example 2 | Thienyl | 85 | 1.38 | Boehmite | 530 | 3.05 | 17.35% | 8.67% |
| | polyamide | | | | | | | |
| Example 3 | Polyetherimide | 50 | 1.27 | Magnesium | 800 | 2.36 | 7.56% | 4.22% |
| | | | | hydroxide | | | | |
| Example 4 | Thienyl | 85 | 1.38 | Boehmite | 530 | 3.05 | 17.35% | 8.67% |
| | polyamide | | | | | | | |
| Example 5 | Thienyl | 200 | 1.38 | Boehmite | 530 | 3.05 | 33.06% | 18.27% |
| | polyamide | | | | | | | |
| Example 6 | Thienyl | 120 | 1.38 | Boehmite | 530 | 3.05 | 22.86% | 11.82% |
| | polyamide | | | | | | | |
| Example 7 | Thienyl | 85 | 1.38 | Boehmite | 530 | 3.05 | 17.35% | 8.67% |
| | polyamide | | | | | | | |
| Comparative | PVDF- | 230 | 1.78 | Boehmite | 530 | 3.05 | 36.23% | 24.90% |
| Example 1 | HFP | | | | | | | |

Note: DP is an average particle size of the heat-resistant polymer particle, ρP is a density of the heat-resistant polymer particle, DT is an average particle size of the inorganic filler, ρT is a density of the inorganic filler, VP₀ is a critical volume concentration of the heat-resistant polymer particle, VT₀ is a critical volume concentration of the inorganic filler, and MP₀ is a critical mass concentration of the heat-resistant polymer particle.

As can be seen from the results in Tables 1-3, the composite separator comprising the heat-resistant polymer particle and the inorganic filler prepared in Examples 1-5 not only has good thermal-shrinkage resistance, but also has a high rupture temperature, and the rupture temperatures are all more than 200° C., greatly improving the thermal stability of the composite separator in lithium-ion batteries, which cannot be achieved by a water-based ceramic coating method.

In addition, it can be seen that the concentration of the heat-resistant polymer particle in Example 2 is less than the critical concentration VP₀ corresponding to the particle size, but the inorganic filler with a small particle size (50 nm) is added, so that the heat-resistant polymer particle and the small-sized inorganic filler together form a heat-resistant three-dimensional network structure, thereby realizing a high rupture temperature. When the concentration of the heat-resistant polymer particle is less than the critical concentration corresponding to the particle size, the heat-resistant polymer particle cannot bond with each other to form a heat-resistant three-dimensional network structure, and although the coated separator has a good thermal-shrinkage resistance, the rupture temperature is only 150° C. For example, the inorganic filler in Example 6 has a particle size greater than 100 nm, and when the concentration of the heat-resistant polymer particle is less than the critical concentration VP₀ corresponding to the particle size, the three-dimensional network structure is hardly to be formed, which affects the thermal stability of the composite separator, and thus a high rupture temperature cannot be achieved.

In Example 7, although the concentration of heat-resistant polymer particle is greater than the critical concentration corresponding to the particle size, the silane coupling agent is not added, so that the bonding strength among the heat-resistant particles is weak, and the heat-resistant polymer particle cannot form a heat-resistant three-dimensional network structure. The coated separator has good thermal-shrinkage resistance, but its rupture temperature is only 150° C.

In Example 4, no inorganic filler is added to the composite separator, and the heat-resistant coating has a large number of cracks on the surface due to only containing the heat-resistant polymer particle, the coated separator has poor thermal-shrinkage resistance and low electrolyte wettability, and it can be seen that the compounding of the heat-resistant polymer particle and the inorganic filler is better for the performance of the composite separator.

In Comparative Example 1, PVDF-HFP is used as a polymer to prepare the coating. At high temperature, PVDF-HFP easily loses strength, resulting in that the separator cracks and peels off from the porous substrate.

The oven method was used to test the rupture temperature of the composite separator: the composite separators in Example 2 and Comparative Example 1 were subjected to heat treatment at a temperature of 180° C. for 1 h, and the separator condition and separator resistance before and after the heat treatment were recorded. The separator before and after the heat treatment was put in a button cell to test the resistance. The test results are shown in Table 4.

TABLE 4

| Before heat | |
|---|---|
| treatment | After heat treatment |

| | Separator | Separator | Separator |
|---|---|---|---|
| Example | resistance (Ω) | condition | resistance (Ω) |
| Example 2 | 2.0 | Not ruptured | 3.2 × 10⁵ |
| Comparative | 2.4 | Ruptured | — |
| Example 1 | | | |

It can be seen that the separator in Example 2 is not ruptured after heat treatment at 180° C. for 1 h, and the resistance of the separator is more than 10³Ω. The resistance of the composite separator changes greatly, and the composite separator has a thermal closing effect, which indicates that the composite separator has a high rupture temperature and improves the safety of the battery. In Comparative Example 1, the separator is ruptured after the heat treatment, which is often an important factor leading to battery accidents.

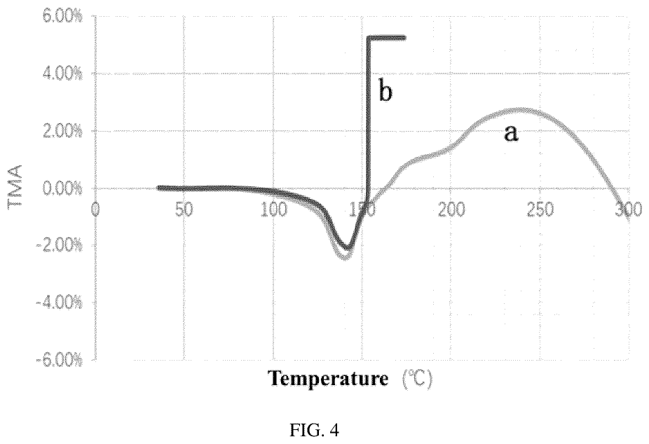

FIG. 4 shows rupture temperature curves from TMA test of the composite separator prepared in Example 2 and Example 7 of the present application, wherein a—the curve of Example 2 and b—the curve of Example 7. It can be seen that the composite separator prepared in Example 7 is ruptured at 150° C., whereas the rupture temperature of the composite separator of Example 2 is already higher than 200° C.

Taking the above ideal embodiments of the present application as a revelation, through the contents of the above specification, the related person can completely carry out various changes and modifications without deviating from the technical ideas of the present application. The technical scope of the present application is not limited to the contents of the specification, but must be defined by the scope of the claims.

1. A composite separator, which comprises:
a porous substrate and a heat-resistant coating arranged on one surface or both surfaces of the porous substrate, wherein the heat-resistant coating contains a heat-resistant polymer particle, an inorganic filler, and an auxiliary binder;
a volume concentration of the heat-resistant polymer particle is VP₁ relative to the heat-resistant polymer particle and the inorganic filler, a critical volume concentration of the heat-resistant polymer particle is VP₀, and a volume concentration of the inorganic filler with a particle size of less than 100 nm is VP₂ relative to the heat-resistant polymer particle and the inorganic filler; VP₀, VP₁, and VP₂ meet the following conditions:
(a) in a case where the inorganic filler is one filler or a mixture of a plurality of fillers and the inorganic filler has an average particle size of greater than 100 nm, the condition of VP₀≤VP₁≤100% is met;
(b) in a case where the inorganic filler is a mixture of a plurality of fillers and at least one filler has an average particle size of less than 100 nm, the condition of VP₀≤VP₁+VP₂≤100% is met;
wherein VP₀-0.685*DP/(0.685*DP+0.5233DT), DP is an average diameter of the heat-resistant polymer particle, and DT is an average diameter of the inorganic filler.

2. The composite separator according to claim 1, wherein the heat-resistant polymer particle contains a heat-resistant resin having an average particle size of 10-200 nm and a glass transition temperature of more than or equal to Ts+40° C., wherein Ts is a melting point of the porous substrate, and the heat-resistant resin has a weight-average molecular mass of 4.0×10⁴-2×10⁶ g/mol; the inorganic filler has an average particle size of 10-1000 nm, and the inorganic filler is selected from at least one of ceramic, a metal oxide, a metal hydroxide, a metal carbonate, silicate, esakaolin, talc, mineral, and glass.

3. The composite separator according to claim 2, wherein the heat-resistant resin is selected from at least one of polyimide, aramid 1414, aramid 1413, aramid 1313, thienyl aramid, pyrrolyl aramid, furanyl aramid, pyridyl polyamide, polyamide-imide, polyetherimide, polysulfone, polyketone, polyether ketone, polyether ether ketone, poly(p-phenylene benzobisoxazole), and cellulose.

4. The composite separator according to claim 2, wherein the inorganic filler is selected from at least one of boehmite, aluminum oxide, silicon dioxide, barium titanate, titanium dioxide, zinc oxide, magnesium oxide, magnesium hydroxide, zirconium oxide, or an oxide solid electrolyte.

5. The composite separator according to claim 1, wherein a volume ratio of the heat-resistant polymer particle to a total volume of the heat-resistant polymer particle and the inorganic filler is VP₀ to 0.5×(VP₀+1).

6. The composite separator according to claim 5, wherein the volume ratio of the heat-resistant polymer particle to the total volume of the heat-resistant polymer particle and the inorganic filler is VP₀ to 0.5×(VP₀+0.7).

7. The composite separator according to claim 1, wherein the auxiliary binder comprises a binder and a coupling agent, an additive amount of the binder is 0.5-10 wt % of a total mass of the heat-resistant polymer particle and the inorganic filler, and an additive amount of the coupling agent is 1-20 wt % of a total mass of the heat-resistant polymer particle and the inorganic filler.

8. The composite separator according to claim 7, wherein the coupling agent is a silane coupling agent, and a content of Si atoms introduced from the silane coupling agent in the heat-resistant coating is 0.05-5 wt % of a mass of the heat-resistant coating.

9. The composite separator according to claim 8, wherein the binder is selected from at least one of polyvinyl alcohol, polyacrylic acid, polyurethane, polyimide, and carboxymethyl cellulose, and the silane coupling agent is selected from at least one of vinyltriethoxysilane, vinyltrimethoxysilane, vinyltris(β-methoxyethoxy) silane, γ-aminopropyltriethoxysilane, γ-glycidoxypropyltrimethoxysilane, and γ-methacryloxypropyl trimethoxysilane.

10. The composite separator according to claim 1, wherein a thickness of the porous substrate is 1-25 μm; a Gurley value of the porous substrate is 20-300 s/100 cc; a material of the porous substrate is a thermoplastic resin having a melting point of less than 200° C.; a loading amount of the heat-resistant coating is 1-9 g/m².

11. The composite separator according to claim 10, wherein the thermoplastic resin is selected from polyethylene terephthalate and/or polyolefin; the polyolefin has a weight-average molecular mass Mw of 100000-5000000, and the polyolefin is polyethylene and/or polypropylene.

12. A preparation method for the composite separator according to claim 1, comprising the following step:
(1) synthesizing a heat-resistant resin;
(2) preparing a dispersion of a heat-resistant polymer particle by using the heat-resistant resin obtained in step (1);
(3) preparing a coating slurry: adding the dispersion of the heat-resistant polymer particle obtained in step (2), an inorganic filler, a binder and a coupling agent to a water-based solvent and mixing well to obtain the coating slurry;
the water-based solvent is selected from one or a mixed solution of more than one of deionized water, ethanol, ethylene glycol, glycerol, isopropanol, propylene glycol, butanol, and acetic acid; the coating slurry further comprises one or more of 0.05-7 wt % of a surfactant, 0.05-9 wt % of a dispersant, 0.02-7 wt % of a wetting agent and 0.04-4 wt % of a defoaming agent added based on a mass of the coating slurry; and
(4) coating the coating slurry on any one surface or both surfaces of the porous substrate and curing to obtain the composite separator.

13. The preparation method for the composite separator according to claim 12, wherein the coating slurry in step (3) has a solid content of 2-80%, and a method for the coating in step (4) is selected from at least one of an electrostatic spraying method, a blade-coating method, a spin-coating method, an extrusion coating method, a transfer coating method, an immersion coating method, and a gravure or micro-gravure coating method.

14. The preparation method for the composite separator according to claim 13, wherein the coating slurry has a solid content of 4-40%.

15. The preparation method for the composite separator according to claim 12, wherein step (4) further comprises performing a surface treatment on the porous substrate, and the surface treatment is any one of a corona treatment, a plasma treatment, a flame treatment, and a UV irradiation treatment.

16. (canceled)

17. A method for preparing a lithium-ion battery, which comprises using the composite separator according to claim 1, a positive electrode and a negative electrode.
